(19) United States
(12) Patent Application Publication
(10) Pub. No.: US 2007/0154507 A1
(43) Pub. Date: Jul. 5, 2007

(54) Antimicrobial agent to inhibit the growth of microorganism on clothing

(76) Inventors: David L. Patton, Webster, NY (US); John R. Fredlund, Rochester, NY (US); Syamal K. Ghosh, Rochester, NY (US); Joseph A. Manico, Rochester, NY (US); Mark S. Fornalik, Rochester, NY (US); Lori L. Rayburn-Zammiello, Rochester, NY (US); Brian P. Aylward, Rochester, NY (US); John E. Frenett, Spencerport, NY (US)

Correspondence Address: Pamela R. Crocker;Patent Legal Staff, Eastman Kodak Company, 343 State Street, Rochester, NY, 14650-2201, US

(21) Appl. No.: 11/323,411

(22) Filed: Dec. 30, 2005

(51) Int. Cl. A01N 59/16; A01N 25/00

(52) U.S. Cl. 424/405; 424/618; 442/123; 977/902

(57) ABSTRACT

The present disclosure relates to an article having a fiber including an antimicrobial agent to inhibit growth of microorganisms on clothing. The article inhibits the growths of microorganisms in biological and physiological fluids. The article includes a fibrous structure and silver halide particles applied to the fibers to inhibit the growth of the microorganism.

### CROSS REFERENCE TO RELATED APPLICATIONS

This application is related to the following co-pending and commonly-assigned patent applications, which are incorporated herein by reference in their respective entirety:

U.S. Ser. No. ______ filed concurrently herewith by David L. Patton, Syamal K. Ghosh, Joseph A. Manico, John R. Fredlund, Lori L. Rayburn-Zammiello, Brian P. Aylward, Mark S. Fornalik and John E. Frenett, entitled ANTIMICROBIAL AGENT TO INHIBIT THE GROWTH OF MICROORGANISM ON DISPOSABLE PRODUCTS (docket 91,789).

U.S. Ser. No. ______ filed concurrently herewith by David L. Patton, Syamal K. Ghosh, Joseph A. Manico, John R. Fredlund, Brian P. Aylward, Mark S. Fornalik, John E. Frenett and Lori L. Rayburn-Zammiello, entitled ANTIMICROBIAL AGENT TO INHIBIT THE GROWTH OF MICROORGANISMS ON OUTERWEAR USED IN THE MEDICAL PROFESSION (docket 91,987).

U.S. Ser. No. ______ filed concurrently herewith by Joseph A. Manico, David L. Patton, John R. Fredlund, Syamal K. Ghosh, Lori L. Rayburn-Zammiello, Mark S. Fornalik, Brian P. Aylward, and John E. Frenett, entitled ANTIMICROBIAL AGENT TO INHIBIT THE GROWTH OF MICROORGANISM ON BUILDING MATERIALS (docket 91,988).

### FIELD OF THE INVENTION

The present invention relates to an article having a fiber with an antimicrobial agent to inhibit growth of microorganisms. More particularly, a fiber with an antimicrobial composition of specific silver salts and polymeric binders attached. The composition can be used to provide antimicrobial activity to the article for inhibiting the growth of microorganisms in solutions as well as on the surface of the fiber.

### BACKGROUND OF THE INVENTION

In recent years people have become very concerned about exposure to the hazards of microbe contamination. For example, exposure to certain strains of Escherichia coli through the ingestion of under-cooked beef can have fatal consequences. Exposure to Salmonella enteritidis through contact with unwashed poultry can cause severe nausea. Mold (Aspergillis niger) and yeast (Candida albicans) can cause respiratory problems and skin infections. There is, in addition, increasing concern over pathogens, such as Salmonella and E. coli: O: 157, present in medical environments and concern over viruses such as Influenza, SARS, AIDS, and hepatitis. Indeed, some forms of bacteria, including Staphylococcus aureus are resistant to all but a few or one known antibiotic.

Noble metal-ions such as silver and gold ions are known for their antimicrobial properties and have been used in medical care for many years to prevent and treat infection. In recent years, this technology has been applied to consumer products to prevent the transmission of infectious disease and to kill harmful bacteria such as Staphylococcus aureus and Salmonella. In common practice, noble metals, metal-ions, metal salts or compounds containing metal-ions having antimicrobial properties, and other antimicrobial materials such as chlorophenyl compounds (Triclosan™), isothiazolone (Kathon™), antibiotics, and some polymeric materials, can be applied to surfaces to impart an antimicrobial property to the surface. If, or when, the surface is inoculated with harmful microbes, the antimicrobial metal-ions or metal complexes, if present in effective forms and concentrations, will slow or even prevent altogether the growth of those microbes. In addition, such compounds can be formed into, or coated upon, articles such as bandages, wound dressings, casts, personal hygiene items, etc.

In order for an antimicrobial article to be effective against harmful microorganisms, the antimicrobial compound must come in direct contact with microorganisms present in the surrounding environment, such as food, liquid nutrient or biological or non-biological fluid. Since physiological fluids are often extraordinarily complex, the treatment of a multitude of microbial contaminants can be difficult, if not impossible, with one antimicrobial compound. Further, the antimicrobial ions or compounds can be precipitated or complexed by components of the biological or physiological fluids and rendered ineffective. Microorganisms can develop resistance to organic compounds such as triclosan. Still further, microorganisms such as bacteria can develop resistance to antibiotics, biocides and antimicrobials, and more dangerous microbes can result.

The antimicrobial properties of silver have been known for several thousand years. The general pharmacological properties of silver are summarized in “Heavy Metals”—by Stewart C. Harvey and “Antiseptics and Disinfectants: Fungicides; Ectoparasiticides”—by Stewart Harvey in The Pharmacological Basis of Therapeutics, Fifth Edition, by Louis S. Goodman and Alfred Gilman (editors), published by MacMillan Publishing Company, NY, 1975. It is now understood that the affinity of silver ion to biologically important moieties such as sulfhydryl, amino, imidazole, carboxyl and phosphate groups are primarily responsible for its antimicrobial activity.

The attachment of silver ions to one of these reactive groups on a protein results in the precipitation and denaturation of the protein. The extent of the reaction is related to the concentration of silver ions. The diffusion of silver ion into mammalian tissues is self-regulated by its intrinsic preference for binding to proteins through the various biologically important moieties on the proteins, as well as precipitation by the chloride ions in the environment. Thus, the very affinity of silver ion to a large number of biologically important chemical moieties (an affinity which is responsible for its action as a germicidal/biocidal/viricidal/fungicidal/bacteriocidal agent) is also responsible for limiting its systemic action—silver is not easily absorbed by the body. This is a primary reason for the tremendous interest in the use of silver containing species as an antimicrobial, i.e., an agent capable of destroying or inhibiting the growth of microorganisms, such as bacteria, yeast, fungi and algae, as well as viruses.

In addition to the affinity of silver ions to biologically relevant species that leads to the denaturation and precipitation of proteins, some silver compounds, those having low ionization or dissolution ability, also function effectively as antiseptics. Distilled water in contact with metallic silver becomes antibacterial even though the dissolved concentration of silver ions is less than 100 ppb. There are numerous mechanistic pathways by which this oligodynamic effect is manifested, i.e., ways in which silver ion interferes with the basic metabolic activities of bacteria at the cellular level to provide a bactericidal and/or bacteriostatic effect.

A detailed review of the oligodynamic effect of silver can be found in “Oligodynamic Metals” by I. B. Romans in Disinfection Sterilization and Preservation, C. A. Lawrence and S. S. Bloek (editors), published by Lea and Fibiger (1968) and “The Oligodynamic Effect of Silver” by A. Goetz, R. L. Tracy and F. S. Harris, Jr. in Silver in Industry, Lawrence Addicks (editor), published by Reinhold Publishing Corporation, 1940. These reviews describe results that demonstrate that silver is effective as an antimicrobial agent towards a wide range of bacteria, and that silver can impact a cell through multiple biochemical pathways, making it difficult for a cell to develop resistance to silver. However, it is also known that the efficacy of silver as an antimicrobial agent depends critically on the chemical and physical identity of the silver source. The silver source can be silver in the form of metal particles of varying sizes, silver as a sparingly soluble material such as silver chloride, silver as a highly soluble salt such as silver nitrate, etc. The efficiency of the silver also depends on i) the molecular identity of the active species—whether it is Ag⁺ ion or a complex species such as (AgCl₂)⁻, etc., and ii) the mechanism by which the active silver species interacts with the organism, which depends on the type of organism. Mechanisms can include, for example, adsorption to the cell wall which causes tearing; plasmolysis where the silver species penetrates the plasma membrane and binds to it; adsorption followed by the coagulation of the protoplasm; or precipitation of the protoplasmic albumin of the bacterial cell. The antibacterial efficacy of silver is determined, among other factors, by the nature and concentration of the active species; the type of bacteria; the surface area of the bacteria that is available to interaction with the active species; the bacterial concentration; the concentration and/or the surface area of species that could consume the active species and lower its activity; and the mechanisms of deactivation.

It is clear from the literature on the use of silver based materials as antibacterial agents that there is no general procedure for precipitating silver based materials and/or creating formulations of silver based materials that would be suitable for all applications. Since the efficacy of the formulations depends on so many factors, there is a need for i) a systematic process for generating the source of the desired silver species, ii) a systematic process for creating formulations of silver based materials with a defined concentration of the active species; and iii) a systematic process for delivering these formulations for achieving predetermined efficacy. There is particularly a need for processes that are simple and cost effective.

One very important use of silver based antimicrobials is for textiles. Various methods are known in the art to render antimicrobial properties to a target fiber. The approach of embedding inorganic antimicrobial agents, such as zeolites, into low melting components of a conjugated fiber is described in U.S. Pat. No. 4,525,410 and U.S. Pat. No. 5,064,599. In another approach, the antimicrobial agent can be delivered during the process of making a synthetic fiber such as those described in U.S. Pat. No. 5,180,402, U.S. Pat. No. 5,880,044, and U.S. Pat. No. 5,888,526, or via a melt extrusion process as described in U.S. Pat. No. 6,479,144 and U.S. Pat. No. 6,585,843. In still yet another process, an antimicrobial metal ion can be ion exchanged with an ion exchange fiber as described in U.S. Pat. No. 5,496,860.

Methods of transferring an antimicrobial agent, in the form of an inorganic metal salt or zeolite, from one substrate to a fabric are disclosed in U.S. Pat. No. 6,461,386. High-pressure laminates containing antimicrobial inorganic metal compounds are disclosed in U.S. Pat. No. 6,248,342. Deposition of antimicrobial metals or metal-containing compounds onto a resin film or target fiber has also been described in U.S. Pat. No. 6,274,519 and U.S. Pat. No. 6,436,420.

It is also known in the art that fibers can be rendered with antimicrobial properties by applying a coating of silver particles. Silver ion-exchange compounds, silver zeolites and silver glasses are all known to be applied to fibers through topical applications for the purpose of providing antimicrobial properties to the fiber as described in U.S. Pat. No. 6,499,320, U.S. Pat. No. 6,584,668, U.S. Pat. No. 6,640,371 and U.S. Pat. No. 6,641,829. Other inorganic antimicrobial agents can be contained in a coating that is applied to a fiber as described in U.S. Pat. No. 5,709,870, U.S. Pat. No. 6,296,863, U.S. Pat. No. 6,585,767 and U.S. Pat. No. 6,602,811.

It is known in the art to use binders to apply coating compositions to impart antimicrobial properties to various substrates. U.S. Pat. No. 6,716,895 describes the use of hydrophilic and hydrophobic polymers and a mixture of oligodynamic metal salts as an antimicrobial composition, in which the water content in the coating composition is preferably less than 50%. The mixture of oligodynamic metal salts are intended to span a wide range of solubilities and would not be useful in a durable coating application. U.S. Pat. No. 5,709,870 describes the use of carboxymethyl cellulose-silver complexes to provide an antimicrobial coating to a fiber. The use of silver halides in an antimicrobial coating, particularly for medical devices, is described in U.S. Pat. No. 5,848,995.

In particular, the prior art has disclosed formulations that are useful for highly soluble silver salts having solubility products, herein referred to as pKsp, of less than 1. Generally, these silver salts require the use of hydrophobic addenda to provide the desired combinations of antimicrobial behavior and durability. Conversely, it is also know that very insoluble metallic silver particles, having a pKsp greater than 15, would require hydrophilic addenda to provide the desired combinations of antimicrobial behavior and durability.

It is also well known in the photographic art that gelatin is a useful hydrophilic polymer in the production of photographic silver halide emulsions. Gelatin is present during the precipitation of, for example, silver chloride from its precursor salts. For most practical photographic coating formulations, the amount of gelatin is above 3% during the precipitation stages and preferably above 10% during the coating applications for film or paper products. It is a desirable feature that the gelatin is present in an amount sufficient to solidify or gel the composition. This is desired to minimize settling of the dense silver halide particles. The high gelatin levels are themselves a source of bioactivity and it is common practice to add biostats or biocides to minimize or prevent spoilage of the photographic emulsion prior to the coating application.

### SUMMARY OF THE INVENTION

In general terms, the present disclosure relates to inhibiting the growth of microorganisms by applying silver halide particles to the fibers of an article.

In one embodiment, an article having an antimicrobial agent to inhibit the growth of microorganisms in biological, non-biological and physiological fluids is presented. The article includes a structure having fibers; and silver halide particles bound to the fibers using a hydrophilic gelatin polymer composition that does not substantially solidify or gel.

In another embodiment, a method for creating an article having an antimicrobial agent to inhibit the growth of microorganisms in biological, non-biological and physiological fluids is presented. The method including providing a structure having fibers, and binding silver halide particles to the fibers using a hydrophilic gelatin polymer composition that does not substantially solidify or gel.

In yet another embodiment, a method for creating an article having an antimicrobial agent to inhibit the growth of microorganisms in biological, non-biological and physiological fluids is presented, the method including providing a structure having fibers, binding silver halide particles to the fibers using a hydrophilic gelatin polymer composition which does not substantially solidify or gel, and applying a hydrophobic binder resin to the fibers.

### BRIEF DESCRIPTION OF THE DRAWINGS

FIG. 1 is a photograph showing untreated fibers;

FIGS. 2A and B are photographs showing fibers treated with silver halide particles in accordance with the present invention;

FIG. 3 illustrates a plan view of a suitcase made in accordance with the present invention;

FIG. 4 illustrates a plan view of a garment made in accordance with the present invention; and

FIG. 5 is an enlarged partial cross sectional view of a portion of the garment of FIG. 4 as taken along line 4-4.

### DETAILED DESCRIPTION OF THE INVENTION

Various embodiments will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

This invention can be applied to textiles to provide antibacterial and/or anti-fungal protection to the textile in a variety of end-use applications. Topical application of this material is accomplished through traditional padding technology (dip coating), followed by a short, high-temperature curing step to permanently link the antimicrobial material to the textile. Typical end-use applications include active wear (apparel worn during a sport or physical activity, such as running or cycling shirts, gym suits, golf and tennis wear, etc); athletic wear (apparel worn for sporting events, such as team jerseys, socks, athletic shorts, etc.); undergarments (apparel worn in direct contact with the skin, such as undershirts, underwear, bras, etc.); uniforms (apparel typically worn by organizations such as schools, hospitals, and manufacturing workers garments, where a garment is exposed to aggressive and harsh cleaning treatments to allow the garment to be worn by more than one person); and home furnishings (such as bed linens, bath towels, pillow cases, sheets, hospital bed coverings, shower curtains, table cloths, napkins, hand towels, etc.).

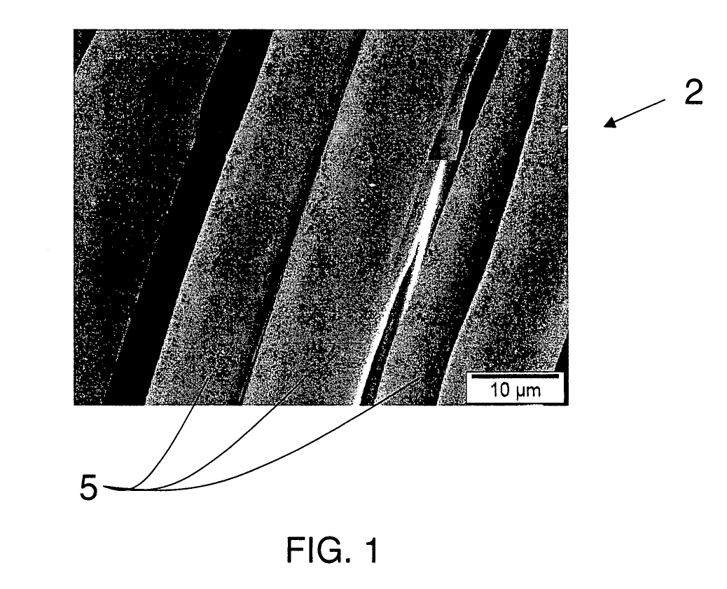

FIG. 1 is a photograph illustrating typical fibers that have not been treated with antimicrobial agents, generally shown as 2. In one embodiment of FIG. 1, numerous fibers 5 can form an article. The fibers 5 have not been treated with an antimicrobial agent, such as silver halide particles.

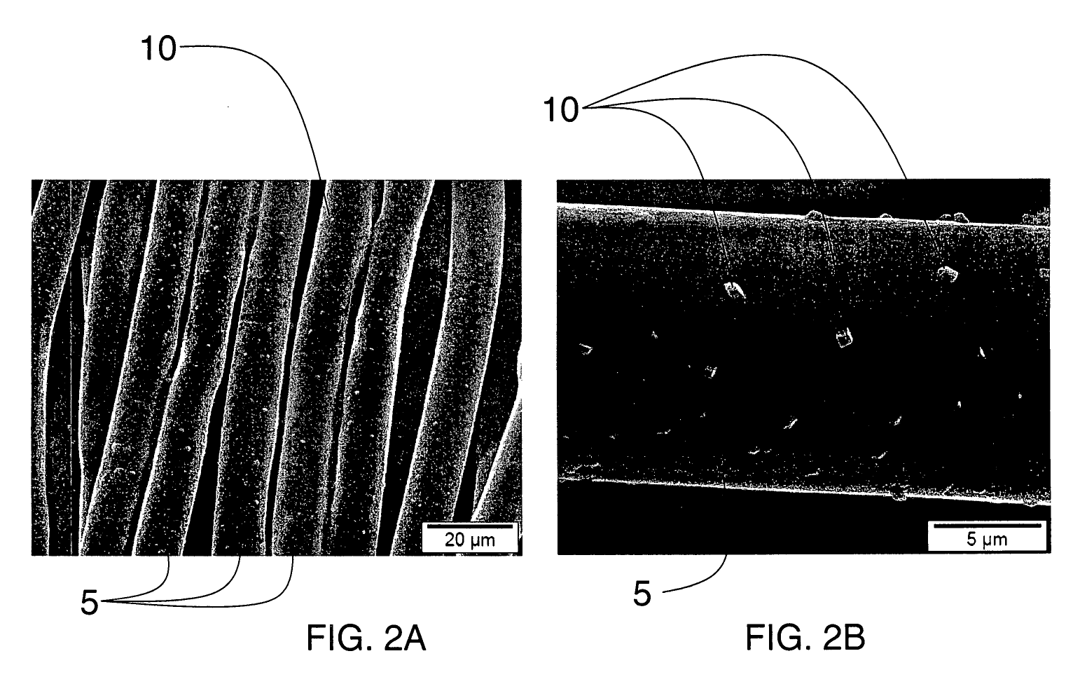

FIGS. 2A is a photograph showing fibers 5 which have been treated using a process that applies silver halide particles 10 and a hydrophilic polymer (not shown) in accordance with one embodiment. Similarly, FIG. 2B is a photograph showing a single fiber 5 with the silver halide particles 10 attached.

The term inhibition of microbial-growth, or a material which “inhibits” microbial growth, is used by the authors to mean materials that prevent microbial growth, subsequently kills microbes so that the population is within acceptable limits, significantly retard the growth processes of microbes or maintain the level or microbes to a prescribed level or range. The prescribed level can vary widely depending upon the microbe and its pathogenicity; generally it is preferred that harmful organisms are present at no more than 10 organisms/ml and preferably less than I organism/ml.

Antimicrobial agents which kill microbes or substantially reduce the population of microbes are often referred to as biocidal agents, while materials which simply slow or retard normal biological growth are referred to as biostatic agents. The preferred impact upon the microbial population can vary widely depending upon the application. For example, in pathogenic organisms (such as Group A streptococcal) a biocidal effect is preferred, while for less harmful organisms a biostatic impact is preferred. Generally, it is preferred that microbiological organisms remain at a level, which is not harmful to the consumer or user of that particular article, or to the function of the treated article.

In one embodiment, an antimicrobial agent composition includes at least 50% water, silver halide particles 10, and a hydrophilic polymer, i.e., hydrophilic binder. The hydrophilic polymer is of a type and used in an amount in which the composition does not substantially gel or solidify at 25 degrees C. In practical terms, the composition, when sold as a concentrate, must be able to flow at 25 degrees C. and be easily mixed with an aqueous diluent or other addenda prior to use as an antimicrobial coating for yam or textile. The composition also encompasses a more diluted form that is suitable for dip, pad, spray or other types of coating.

The composition is substantially free of organic solvents. Preferably, no organic solvent is intentionally added to the composition. The composition must exhibit antimicrobial activity upon drying. In its concentrated form, the composition must include at least 50% water by weight. In another embodiment, the composition includes at least 70% water by weight. In its diluted form, the composition consists of greater than 95% water.

The silver halide particles 10, also known as silver salts, can be of any shape and halide composition. The type of halide can include chloride, bromide, iodide and mixtures of them. The silver halide particles 10 can include, for example, silver bromide, silver iodobromide, bromoiodide, silver iodide or silver chloride. However, the embodiment is not limited to these compositions, and any suitable composition can be used. In one embodiment, the silver halide particles 10 are predominantly silver chloride. The predominantly silver chloride particles 10 can include, but is not limited to, silver chloride, silver bromochloride, silver iodochloride, silver bromoiodochloride and silver iodobromochloride particles. By predominantly silver chloride, it is meant that the particles are greater than about 50 mole percent silver chloride. Preferably, they are greater than about 90 mole percent silver chloride, and optimally greater than about 95 mole percent silver chloride. The silver halide particles 10 can either be homogeneous in composition or the core region can have a different composition than the shell region of the particles. The shape of the silver halide particles can be cubic, octahedral, tabular or irregular. More silver halide properties can be found in “The Theory of the Photographic Process”, T. H. James, ed., 4th Edition, Macmillan (1977). In another embodiment the silver halide particles have a mean equivalent circular diameter of less than 1 micron, and preferably less 0.5 microns.

The silver halide particles 10 and associated coating composition of the present embodiment are applied to the fiber 5 or fabric in an amount sufficient to provide antimicrobial properties to the treated fiber for a minimum of at least 10 washes, more preferably 20 washes and most preferably after 30 washes in accordance with ISO 6330:2003 (other antimicrobial textile test methods include AATCC-100 and New York State Proposed Method 1241). The amount of silver halide particles 10 applied to the target fiber 5 or textile fabric is determined by the desired durability or length of time of antimicrobial properties. The amount of silver halide particles 10 present in the composition will depend on whether the composition is one being sold in a concentrated form suitable for dilution prior to coating or whether the composition has already been diluted for coating.

Typical levels of silver salt particles (by weight percent) in the formulation are preferably from about 0.000001% to about 10%, more preferably from about 0.0001% to about 1% and most preferably from about 0.001% to 0.5%. In a concentrated format, the composition preferably includes silver halide particles in an amount of 0.001 to 10%, more preferably 0.001 to 1%, and most preferably 0.001 to 0.5%. In a diluted format, the composition preferably includes silver halide particles in an amount from about 0.000001% to about 0.01%, more preferably from about 0.00001% to about 0.01% and most preferably from about 0.0001% to 0.01%. It is a desirable feature of the embodiment to provide efficient antimicrobial properties to the target fiber or textile fabric at a minimum silver halide level to minimize the cost associated with the antimicrobial treatment.

In one embodiment, the preferred hydrophilic polymers are soluble in water at concentrations greater than approximately 2%, preferably greater than approximately 5%, and more preferably greater than approximately 10%. Therefore, suitable hydrophilic polymers do not require an organic solvent to remain fluid at 25 degrees C. Suitable hydrophilic polymers useful in the embodiment include, for example, gelatin, polyacrylic acid, polyacrylamide, polyvinyl alcohol, polyvinylpyrrolidones, cellulose etc. into the reaction vessel. The polymers peptize or stabilize silver halide particles help maintain colloidal stability of the solution.

In another embodiment, a preferred hydrophilic polymer is gelatin. Gelatin is an amphoteric polyelectrolyte that has excellent affinity to a number of substrates. The gelatin can be processed by any of the well-known techniques in the art including, but not limited to: alkali-treatment, acid-treatment, acetylated gelatin, phthalated gelatin or enzyme digestion. The gelatin can have a wide range of molecular weights and can include low molecular weight gelatins if it is desirable to raise the concentration of the gelatin in the inventive composition without solidifying the composition. The gelatin in the present embodiment is added in an amount sufficient to peptize the surface of the silver halide and some excess of gelatin will always be present in the water phase. The gelatin level can be chosen such that the composition does not substantially solidify or gel. In the present embodiment, the weight percentage of gelatin is less than 3%, preferably less than 2%, and more preferably less than 1%. The gelatin of the present embodiment can also be cross-linked in order to improve the durability of the coating composition containing the antimicrobial silver halide particles 10.

Silver halide particles can be formed by reacting silver nitrate with halide in aqueous solution. In the process of silver halide precipitation, one can add the hydrophilic polymers to peptize the surface of the silver halide particles thereby imparting colloidal stability to the particles, see for example, Research Disclosure September 1997, Number 401 published by Kenneth Mason Publications, Ltd., Dudley Annex, 12a North Street, Emsworth, Hampshire PO10 7DQ, ENGLAND, the contents of which are incorporated herein by reference.

In addition to the hydrophilic binder, a hydrophobic binder resin is preferably used to improve the adhesion and durability of the silver salt particles once applied to a fabric surface. Such hydrophobic binders are well known in the art and are typically provided as aqueous suspensions of polymer microparticles. Materials suitable for use as hydrophobic binders include, but are not limited to, acrylic, styrene-butadiene, polyurethane, polyester, polyvinyl acetate, polyvinyl acetal, vinyl chloride and vinylidine chloride polymers, including copolymers thereof. In one embodiment, acrylic polymers and polyurethane are preferred.

The hydrophobic binders should have film-forming properties that include a range of glass transition temperatures from about −30 C to about 90 C. The hydrophobic binder particles can have a wide range of particle sizes from about 10 nm to about 10,000 nm and can be poly-dispersed in distribution. The hydrophobic binders can also be thermally or chemically cross-linkable in order to modify the desired durability properties of the antimicrobial fiber or fabric textile. The hydrophobic binders can be nonionic or anionic in nature. Useful ranges of the hydrophobic binders are generally less than about 10% of the composition. It is understood that the choice of the hydrophobic binder can be related to specific end use requirements of the fiber or fabric textile including, wash resistance, abrasion (crock), tear resistance, light resistance, coloration, hand and the like. As described in more detail below the hydrophobic binder is generally kept separate from the hydrophilic polymer/silver halide particle composition until a short time prior to coating.

In one embodiment, a composition including silver salt particles, hydrophilic binder and optionally, hydrophobic binder or gelatin cross-linker, can be applied to the target fiber or textile fabric in any of the well know techniques in art. These techniques include, but are not limited to, pad coating, knife coating, screen coating, spraying, foaming and kiss-coating. The components of the composition are preferably delivered as a separately packaged two-part system involving colloidal silver halide particles and hydrophilic binder as one part (part A) and a second part (part B) including an aqueous suspension of a hydrophobic binder, or gelatin cross-linker, and optionally, a second hydrophilic binder that can be the same or different as the hydrophilic binder from part A. The first part, including colloidal silver halide particles and hydrophilic binder, has an excellent shelf-life without compromising colloidal stability. The two parts can be combined prior to a padding or coating operation and exhibit colloidal stability for the useful shelf-life of the composition.

There can also be present optional components, for example, thickeners or wetting agents to aid in the application of the composition to the target fiber or textile fabric. Examples of wetting materials include surface active agents commonly used in the art such as ethyleneoxide-propyleneoxide block copolymers, polyoxyethylene alkyl phenols, polyoxyethylene alkyl ethers, and the like. Compounds useful as thickeners include, for example, particulates such as silica gels and smectite clays, polysaccharides such as xanthan gum, polymeric materials such as acrylic-acrylic acid copolymers, hydrophobically modified ethoxylated urethanes, hydrophobically modified nonionic polyols, hydroxypropyl methylcellulose and the like.

Also, an agent to prevent latent image formation is useful in the compositions. Some silver salts are light sensitive and discolor upon irradiation of light. However, the degree of light sensitivity can be minimized by several techniques known to those who are skilled in the art. For example, storage of the silver halide particles in a low pH environment will minimize discoloration. In general, pH below 7.0 is desired and more specifically, pH below 4.5 is preferred. Another technique to inhibit discoloration involves adding compounds of elements, such as, iron, iridium, rhuthinium, palladium, osmium, gallium, cobalt, rhodium, and the like, to the silver halide particles. These compounds are known in the photographic art to change the propensity of latent image formation; and thus the discoloration of the silver salt. Additional emulsion dopants are described in Research Disclosure, February 1995, Volume 370, Item 37038, Section XV.B., published by Kenneth Mason Publications, Ltd., Dudley Annex, 12a North Street, Elmsworth, Hampshire PO10 7DQ, England.

The embodiment is not limited to any particular fiber or textile fabric or yam including, exhaustively any natural or manufactured fibers. Examples of natural fibers include, but are not limited to, cotton (cellulosic), wool, or other natural hair fibers, for example, mohair and angora. Examples of manufactured fibers include synthetics, such as, polyester, polypropylene, nylon, acrylic, polyamide, or, regenerated materials such as cellulosics and the like, or blends of materials such as polyester/cotton. The target fiber or yam can include any number of chemistries or applications prior to, during and/or after the application of the antimicrobial composition including, for example, antistatic control agents, flame retardants, soil resistant agents, wrinkle resistant agents, shrink resistant agents, dyes and colorants, brightening agents, UV stabilizers, lubricants, antimigrants, and the like.

There are many articles where employment of fibers treated with antimicrobial agents is advantageous. An example is any container made with fabrics that are used to carry articles of clothing that have been saturated with perspiration, such as athletic wear. Even though containers like gym bags are often made of synthetic fibers that are not highly absorbent, over time, the container takes on the odor characteristic of sweat-laden athletic wear. This odor often causes the user to discard the container long before its structural usefulness is at an end. Use of fibers and textiles treated with relatively permanent antimicrobial agents such as silver halides allows the useful life of the container to more closely match its structural usefulness.

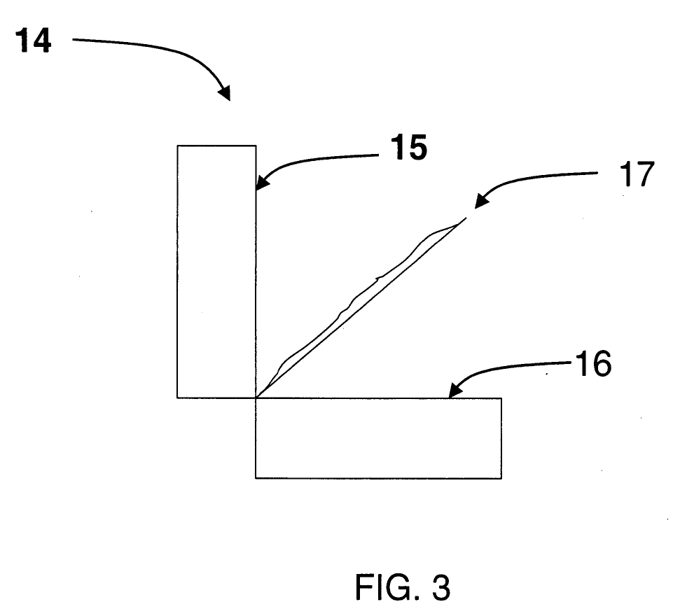

FIG. 3 is one embodiment is a container constructed of fibers treated with antimicrobial agents, generally referred to as 14. This ensures that any surface of the container 14 contacted by the soaked athletic wear, for example, will exhibit antimicrobial characteristics. In another embodiment, a liner material that is in the area of the container and is expected to make contact with the athletic wear is provided. This embodiment is preferred when the mechanical properties of the container are not met by the textile exhibiting antimicrobial properties. The antimicrobial liner can be permanently affixed to the container or can be removable and replaceable so that the container can have a longer useful life. The liner provides antimicrobial properties for minimizing odor over time.

In a container constructed of textiles with antimicrobial treatment such that only the portion of the container is expected to be in contact with clothing that has been worn, the construction can allow for a flexible deployment of the antimicrobial textile. For example, the container 14 in FIG. 3 can be a suitcase that has a section 15 for clean clothing, and a section 16 for worn/dirty clothing. As the clean clothing becomes dirty and is returned to the suitcase, the portion made with textiles with antimicrobial properties expands to accept the dirty clothing. Flexible divider 17, also made with textiles with antimicrobial properties, serves to separate the clean clothing from the dirty clothing. Bags for soiled clothing, whether affixed to a suitcase container or unattached, can benefit from construction of textiles with antimicrobial properties.

Bedding can also benefit from textiles with antimicrobial properties. In particular, items never or infrequently cleaned can be improved by inclusion of textiles that can minimize microbes and resulting odors. Pillows, mattresses, mattress covers, sheets, sleeping bags and blankets can all benefit from the textile. The component portions of these items can also be improved by including textiles with antimicrobial properties. The batting used in the construction of pillows or mattresses will serve to prevent microbes and odors when antimicrobial treated fibers are used. Treating down, a popular material used in bedding, with antimicrobial compounds such as silver halide will inhibit microbes on that material as well.

Camping equipment can benefit from textiles having antimicrobial properties. In many cases, the textiles used for camping gear such as tents, tent flys, tarps and hammocks, can be improved if they are less subject to mildew growth on damp or dirty fabrics. It is often impractical to dry out and clean all camping gear during the act of camping or soon after. Accordingly, constructing items used for camping from textiles made with antimicrobial fibers can minimize the need for immediate drying or cleaning.

Athletic wear typifies the need for textiles having antimicrobial properties. Used athletic wear soon becomes odorous if left for a time without washing. Similarly, items such as underwear and socks exhibit the same odorous problems if worn and not washed soon after. In fact, including fibers having antimicrobial properties can enhance any garment that comes in contact with skin. Further advantages can be gained by using the textiles with antimicrobial properties only in the areas where the need is greatest.

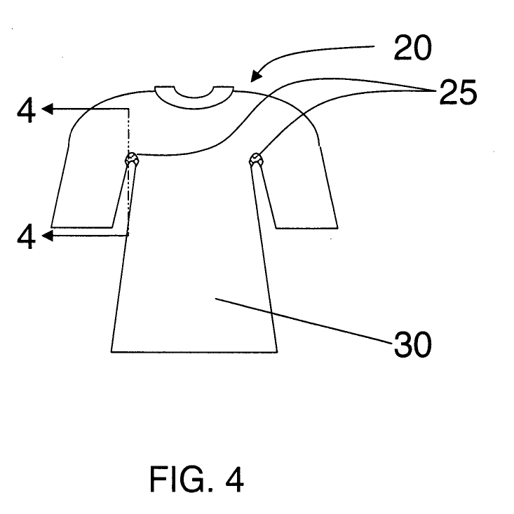

FIG. 4 illustrates one embodiment of a textile having antimicrobial properties. In FIG. 4, an example of a textile, an undershirt 20, is illustrated. The undershirt 20 includes a main body 30 and treated areas 25. These treated areas 25 are areas where moisture and foreign matter are most likely to accumulate. The treated areas 25 include an absorbent material having antimicrobial properties. Accordingly, the undershirt 20 can be constructed such that only treated areas 25 exhibit antimicrobial properties. However, the embodiment is not limited to only the treated areas 25 having antimicrobial properties and any other portions of the textile, or entire of textile, can exhibit antimicrobial properties. For example, undershirt shown in FIG. 4 can be constructed such that antimicrobial properties are limited to areas where moisture and foreign matter are most likely to accumulate. Alternatively, an entire garment can be constructed of textiles with antimicrobial properties, but the concentration of antimicrobial elements such as silver halide compounds can be greater at the areas that accumulate a higher concentration of moisture and foreign matter. Similarly, the toes and plantar regions of socks can be constructed of antimicrobial fibers.

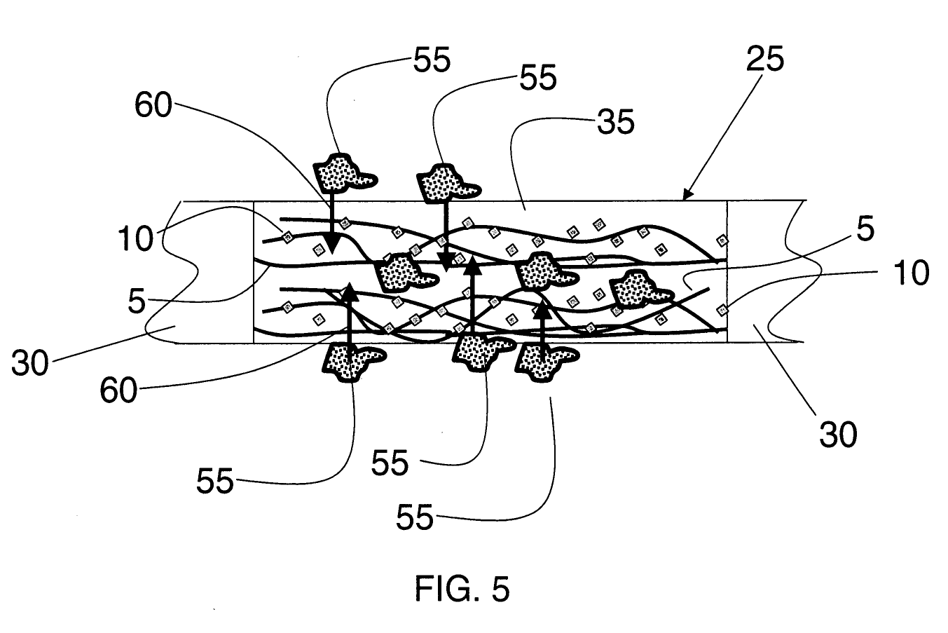

FIG. 5 illustrates an enlarged cross-sectional view 4-4 of the undershirt shown in FIG. 4. The cross-sectional view of the undershirt 20 illustrates the main body 30 and a treated area 25. The treated area 25 includes an absorbent material 35 having antimicrobial properties. The absorbent material 35 can include any fibrous absorbent structures. The fibers 5 are treated with silver halide particles 10 and can be located in the treated area 25. As fluids contact the treated area 25 they are absorbed by the absorbent material 35, allowing the microorganisms 55 to come into close proximity to the silver halide particles 10 as indicated by the arrows 60. By using the sliver halide particles 10 to significantly reduce the amount of microorganisms 55 in the bodily fluids captured by the absorbent material 35 of the undershirt 20, the growth of the microorganism 55 causing odor are eliminated or substantially reduced.

Hats and hatbands can benefit from construction with textiles with antimicrobial properties. Hats and caps often become odiferous and discolored from the action of microbes on perspiration absorbed. Constructing headwear from antimicrobial textiles will extend useful life.

External footwear can also benefit, even if there is no direct contact with skin. The aromatic nature of shoes is well known. Rather than treat the odiferous symptoms, creating footwear with textiles with antimicrobial properties minimizes microbe growth and resulting odor. Antimicrobial agents such as silver halides can also be applied to other popular shoemaking fibrous materials such as leather for the same purpose.

In all the embodiments discussed above, it is preferred that the article is replaced with another identical article after the time in which the effectiveness of the article has substantially decreases. The details and specifications of the articles, support structure, derivatized particles, and metal-ion sequestrant being the same as those described above for the article.

The various embodiments described above are provided by way of illustration only and should not be construed to limit the invention. Those skilled in the art will readily recognize various modifications and changes that can be made to the present invention without following the example embodiments and applications illustrated and described herein, and without departing from the true spirit and scope of the present invention, which is set forth in the following claims.

### PARTS LIST

2 untreated fibers
5 fibers
10 silver halide particles
14 suitcase
15 section for clean clothing
16 section for worn clothing
17 flexible divider
20 undershirt
25 area
30 main body
35 absorbent area
55 microorganism
60 arrow

What is claimed is:

1. An article having an antimicrobial agent to inhibit the growth of microorganisms in biological, non-biological and physiological fluids, the article comprising:
a structure having fibers; and
silver halide particles bound to the fibers using a hydrophilic gelatin polymer composition that does not substantially solidify or gel.

2. The article of claim 1, wherein the weight percentage of the gelatin in the composition is in the range of 1 to 3%.

3. The article of claim 1 further comprising a hydrophobic binder resin applied to the fibers to improve the adhesion and durability of the silver halide particles.

4. The article of claim 3, wherein the hydrophobic binder has film-forming properties with a glass transition temperature ranging from about −30 C to about 90 C.

5. The article of claim 3, wherein the hydrophobic binder has poly-dispersed particles with sizes ranging from about 10 nm to about 10,000 nm.

6. The article of claim 3, wherein the hydrophobic binder comprises one or more of polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene and polypropylene or polyacrylonitrile.

7. The article of claim 1, wherein the silver halide particles further comprises silver halide particles of any shape and halide composition.

8. The article of claim 1, wherein the silver halide particles are selected from the group consisting of chloride, bromide and iodide.

9. The article of claim 8, wherein the group further comprises combinations of chloride, bromide, and iodide.

10. The article of claim 1, where the fibers are placed in contact with biological or physiological fluids of a human or an animal.

11. The article of claim 1, wherein the fibers are incorporated into an article for carrying clothing, a liner for an article for carrying clothing, bedding, athletic wear and undergarments, socks, hats and shoes.

12. The article of claim 1, where the fibers are placed in contact with a damp environment.

13. The article of claim 12, wherein the fibers are incorporated into camping equipment.

14. The article of claim 1, where the fibers are limited to a portion of the structure that is in contact with biological and physiological fluids.

15. The article of claim 1, wherein the silver halide particles maintain microorganisms in a substantially biostatic state.

16. The article of claim 1, wherein the silver halide particles maintain microorganisms to a prescribed level.

17. The article of claim 1, wherein the silver halide particles maintain microorganisms to a level that will not harm users.

18. The article of claim 1, wherein the structure is treated to prevent discoloration.

19. A method for creating an article having an antimicrobial agent to inhibit the growth of microorganisms in biological, non-biological and physiological fluids, the method comprising:
providing a structure having fibers; and
binding silver halide particles to the fibers using a hydrophilic gelatin polymer composition that does not substantially solidify or gel.

20. The method of claim 19, wherein using the hydrophilic gelatin polymer composition further comprises using a hydrophilic gelatin polymer composition having a weight percentage of the gelatin in the range of 1 to 3%.

21. The method of claim 19 further comprising applying a hydrophobic binder resin to the fibers.

22. The method of claim 21, wherein applying the hydrophobic binder further comprises applying a hydrophobic binder having film-forming properties with a glass transition temperature ranging from about −30 C to about 90 C.

23. The method of claim 21, wherein applying the hydrophobic binder further comprises applying a hydrophobic binder having poly-dispersed particles with sizes ranging from about 10 nm to about 10,000 nm.

24. A method for creating an article having an antimicrobial agent to inhibit the growth of microorganisms in biological, non-biological and physiological fluids, the method comprising:
providing a structure having fibers;
binding silver halide particles to the fibers using a hydrophilic gelatin polymer composition which does not substantially solidify or gel; and
applying a hydrophobic binder resin to the fibers.

25. The method of claim 24, wherein using the hydrophilic gelatin polymer composition further comprises using a composition having a weight percentage of the gelatin in the range of 1 to 3%.

26. The method of claim 24, wherein applying the hydrophobic binder further comprises applying a hydrophobic binder having film-forming properties with a glass transition temperature ranging from about −30 C to about 90 C.

27. The method of claim 24, wherein applying the hydrophobic binder further comprises applying a hydrophobic binder having poly-dispersed particles with sizes ranging from about 10 nm to about 10,000 nm.

28. The method of claim 24, wherein binding silver halide particles further comprises applying silver halide particles of any shape and halide composition.

29. The method of claim 24 further comprising placing the structure in contact with biological or physiological fluids of a human or an animal.

30. The method of claim 24, wherein providing the structure further comprises providing an article for carrying clothing, a liner for an article for carrying clothing, bedding, athletic wear and undergarments, socks, hats and shoes.

31. The method of claim 24 further comprising selecting the silver halide particles from the group consisting of chloride, bromide and iodide.

32. The method of claim 31, wherein the group further comprises selecting combinations of chloride, bromide, and iodide

33. The method of claim 24, wherein applying the hydrophobic binder further comprises providing one or more of polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene and polypropylene or polyacrylonitrile.

34. The method of claim 24, further comprises placing the fibers in contact with a damp environment.

35. The method of claim 34, placing the fibers into camping equipment.

36. The method of claim 24, further comprising limiting the fibers to a portion of a structure that is in contact with biological and physiological fluids.

37. The method of claim 24 further comprising maintaining microorganisms in a substantially biostatic state.

38. The method of claim 24 further comprising maintaining microorganisms to a prescribed level.

39. The method of claim 24 further comprising maintaining microorganisms to a level that will not harm users.

40. The method of claim 24 further comprising replacing the structure after a predetermined time period.
